(19) United States
(12) Patent Application Publication
(10) Pub. No.: US 2021/0111483 A1
(43) Pub. Date: Apr. 15, 2021

(54) MICRO-ANTENNA ARRAYS

(71) Applicants: Byron STANLEY, Newton, MA (US); Bryan J. FOX, Wellesley, MA (US); Sanford FREEDMAN, Chelmsford, MA (US)

(72) Inventors: Byron STANLEY, Newton, MA (US); Bryan J. FOX, Wellesley, MA (US); Sanford FREEDMAN, Chelmsford, MA (US)

(21) Appl. No.: 17/066,846

(22) Filed: Oct. 9, 2020

Related U.S. Application Data
(60) Provisional application No. 62/912,791, filed on Oct. 9, 2019.

(51) Int. Cl. H01Q 1/32; H01Q 21/06

(52) U.S. Cl. CPC H01Q 1/3233; H01Q 21/061; H01Q 1/3283

(57) ABSTRACT

A system for navigating a vehicle on a terrain includes a surface-penetrating radar (SPR) system having one or more micro-antenna array having a full frequency range for acquiring real-time SPR information associated with the vehicle and one or more controllers configured to determine information associated with the terrain and/or the vehicle based at least in part on the acquired real-time SPR information. In various embodiments, the micro-antenna array(s) includes multiple micro-antenna elements, each being configured to operate at a frequency range, the frequency ranges of the micro-antenna elements collectively spanning the full frequency range greater than the frequency range of an individual one of the micro-antenna elements.

### CROSS-REFERENCE TO RELATED APPLICATION

This application claims priority to and the benefit of, and incorporates herein by reference in its entirety, U.S. Provisional Patent Application No. 62/912,791, filed on Oct. 9, 2019.

### FIELD OF THE INVENTION

The present invention relates, generally, to micro-antenna arrays and, more particularly, to micro-antenna arrays implemented in surface-penetrating radar (SPR) systems.

### BACKGROUND

Modern wireless communication systems generally feature small-profile, lightweight, and high-gain antennas with simple structures to assure reliability, mobility, and high efficiency. Conventionally, compact antennas rely on electromagnetic (EM) wave resonance; as a result, the sizes of conventional antennas are comparable to the EM wavelength (typically greater than one-tenth of the EM wavelength). Applications such as vehicle localization can depend critically on the size of the antenna. Ultimately, however, antenna miniaturization is limited by considerations of antenna performance, material cost, and viable wavelengths.

A recently developed technique tailors antennas to acoustic wave resonance. For example, acoustically actuated nanomechanical magnetoelectric (ME) antennas with a suspended ferromagnetic/piezoelectric thin-film heterostructure have been proposed to receive and transmit EM waves at their acoustic resonance frequencies via the ME effect. While this technique significantly reduces antenna size by one or two orders of magnitude compared to electromagnetically actuated antennas, ME antennas exhibit a high quality factor (“high Q”), which leads to ringing as well as high sensitivity of the input impedances to small changes in the frequency. The resulting performance degradation limits the utility of these antennas in applications involving wide bandwidths and noisy environments.

Accordingly, there is a need for antennas having sizes comparable to that of the acoustically actuated ME antennas while mitigating the high-Q problems of the acoustically actuated ME antennas.

### SUMMARY

Embodiments of the present invention provide a micro-antenna array that may have an ultra-compact size (e.g., dimensions comparable to those of a conventional microchip) without exhibiting the high-Q problems that have characterized acoustically-actuated ME antennas. In various embodiments, a micro-antenna array includes multiple micro-antenna elements; each element is an acoustically actuated ultra-compact nanoelectromechanical system (NEMS) ME antenna having a suspended ferromagnetic/piezoelectric thin-film heterostructure and capable of operating at a peak frequency between 30 Hz and 3 GHz. To mitigate the effects of high Q, each micro-antenna element is designed (in terms of material and/or configuration (e.g., size or shape)) to operate within a relatively narrow bandwidth (e.g., 2 kHz), but the frequency bands (or frequency ranges) of the elements in the micro-antenna array collectively span a wide spectral region (e.g., from 10 kHz to 10 GHz). In addition, the peak operating frequencies associated with adjacent micro-antenna elements may have a stepped-frequency difference. The operating frequency bands of the micro-antenna elements may overlap one another or may abut one another.

In one embodiment, the micro-antenna elements in the array are operated as a group such that the entire array effectively acts as a single broadband transmitter and/or receiver. Alternatively, the micro-antenna elements in the array may be grouped into multiple series; each series is independently controlled to transmit and/or receive signals within a frequency range collectively determined by the micro-antenna elements in the series. In some embodiments, each micro-antenna element in the array is independently controlled to transmit and/or receive signals in its associated frequency range. Regardless of whether the micro-antenna elements are operated in a grouped or individual manner, the signals transmitted and/or received thereby may be computationally combined to span the broadband spectral frequency range.

In various embodiments, one or more micro-antenna arrays are implemented in an SPR system affixed to a vehicle and operated to acquire road surface and/or subsurface information of the terrain conditions and/or locational information of the vehicle. When multiple micro-antenna arrays are employed, anomalies in the underlying terrain may be detected by comparing the signals received by the arrays. The groupings may be two-dimensional (2D) and/or three-dimensional (3D) configurations that enable multiple inputs and/or output measurements. This can also be achieved by creating a steering beam from one micro-antenna array that can focus in different directions/locations, e.g., by operating the micro-antennas as a phased array. In some embodiments, separate sets of micro-antenna arrays are distributed around the vehicle (e.g., one array in the front of the vehicle and another one in the rear of the vehicle). The front array may map underlying and surface terrain and, based on the map, the rear array may record and register data to the front-array data, thereby revealing the state information (e.g., steering, orientation, velocity, pose, acceleration and/or deceleration) of the vehicle.

Accordingly, in one aspect, the invention pertains to a system for navigating a vehicle on a terrain. In various embodiments, the system includes an SPR system having one or more micro-antenna arrays for acquiring real-time SPR information associated with the vehicle, and one or more controllers configured to, based at least in part on the acquired real-time SPR information, determine information associated with the terrain and/or the vehicle. The micro-antenna array(s) may include multiple micro-antenna elements each being configured to operate at a frequency range, the frequency ranges of the micro-antenna elements collectively spanning a full frequency range greater than the frequency range of an individual one of the micro-antenna elements.

In various embodiments, each of the micro-antenna elements includes an acoustically actuated ultra-compact nanoelectromechanical system (NEMS) ME antenna and has a suspended ferromagnetic/piezoelectric thin-film heterostructure. In addition, each of the micro-antenna elements may have dimensions comparable to those of a conventional microchip. In one implementation, the full frequency range corresponds to frequencies between 10 kHz and 10 GHz. In some embodiments, each micro-antenna element has a peak operating frequency, and the peak operating frequencies associated with adjacent micro-antenna elements have a stepped-frequency difference. The frequency ranges of adjacent micro-antenna elements may overlap each other. Alternatively, the frequency ranges of adjacent micro-antenna elements may abut each other. In one embodiment, the micro-antenna elements are operable over approximately 2 kHz.

In some embodiments, the SPR system includes multiple micro-antenna arrays, each configured to focus at a different region. In addition, the controller may be further configured to compare the SPR information received by the micro-antenna arrays; and determine anomalies in the terrain condition associated with one or more of the regions. In addition, the controller may be further configured to cause the micro-antenna array(s) to generate a steering beam focusing at multiple regions; compare the SPR information received by the micro-antenna array(s) from the plurality of regions; and determine anomalies in the terrain condition associated with one or more of the regions.

In various embodiments, the SPR system includes multiple micro-antenna arrays, each configured to focus at a different region. In addition, the controller may be further configured to based on the SPR information acquired by the first one of the micro-antenna arrays, map the terrain condition; based on the map, record and register the SPR information acquired by the second one of the micro-antenna arrays to the SPR information acquired by the first one of the micro-antenna arrays; and determine state information (e.g., a steering direction, an orientation, a velocity, a pose, an acceleration and/or a deceleration) associated with the vehicle.

Further, the micro-antenna array may be configured to receive multiple input signals or generate multiple output signals at one time so as to shape a beam generated therefrom or improve quality of the acquired real-time SPR information. The micro-antenna array may be configured in two-dimensional or three-dimensional. In some embodiments, the controller is further configured to combine or compare the acquired real-time SPR information over a time period so as to improve accuracy of the determined terrain condition and/or locational information associated with the vehicle.

In various embodiments, the micro-antenna elements are spaced apart from one another with a distance less than one-tenth of an average operating wavelength of the micro-antenna elements in air or on a substrate so as to improve a lateral and/or longitudinal resolution. In addition, the space between two of the micro-antenna elements may be determined based at least in part on a target location resolution and locations of the two micro-antenna elements in the micro-antenna array. In one embodiment, the micro-antenna elements have the same frequency range. Alternatively, all (or at least some) of the micro-antenna elements have different frequency ranges. In addition, the system may further include a single antenna element for acquiring real-time SPR information associated with the vehicle at a frequency range different from the frequency ranges of the micro-antenna elements.

In another aspect, the invention relates to a method of navigating a vehicle on a terrain. In various embodiments, the method includes providing an SPR system having one or more micro-antenna arrays, the micro-antenna array including multiple micro-antenna elements, each being configured to operate at a frequency range, the frequency ranges of the micro-antenna elements collectively spanning a full frequency range; activating the SPR system to acquire real-time SPR information associated with the vehicle; and based at least in part on the acquired real-time SPR information, determining information associated with the terrain and/or the vehicle. In one implementation, wherein the wide frequency range corresponds to frequencies between 10 kHz and 10 GHz. In addition, each micro-antenna element may have a peak operating frequency, and the peak operating frequencies associated with adjacent micro-antenna elements have a stepped-frequency difference.

As used herein, the terms “approximately” and “substantially” mean±10%, and in some embodiments, 5%. In addition, the terms “frequency band” and “frequency range” are used herein interchangeably. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1A schematically depicts an exemplary micro-antenna array in accordance with various embodiments of the present invention.

FIGS. 1B and 1C illustrate exemplary operating frequencies of the micro-antenna elements in accordance with various embodiments of the present invention.

FIG. 2A schematically illustrates an exemplary traveling vehicle including an SPR system in accordance with various embodiments of the present invention.

FIG. 2B schematically illustrates an alternative configuration in which the micro-antenna array of the SPR system is closer to or in contact with the surface of the road in accordance with various embodiments of the present invention.

FIG. 2C schematically depicts an exemplary configuration in which micro-antenna arrays of the SPR system are directed to different regions in accordance with various embodiments of the present invention.

FIG. 2D schematically depicts an exemplary configuration in which micro-antenna arrays of the SPR system are directed to the same region at different angles in accordance with various embodiments of the present invention.

FIG. 2E, depicts a steering beam created by the micro-antenna array of the SPR system in accordance with various embodiments of the present invention.

FIGS. 2F and 2G schematically depict the side view and bottom view, respectively, of separate sets of micro-antenna arrays distributed around the vehicle in accordance with various embodiments of the present invention.

FIGS. 2H and 21 schematically illustrate vehicles equipped with SPR systems and traveling indoors in accordance with various embodiments of the present invention.

FIG. 3 schematically depicts an exemplary SPR system in accordance with various embodiments of the present invention.

### DETAILED DESCRIPTION

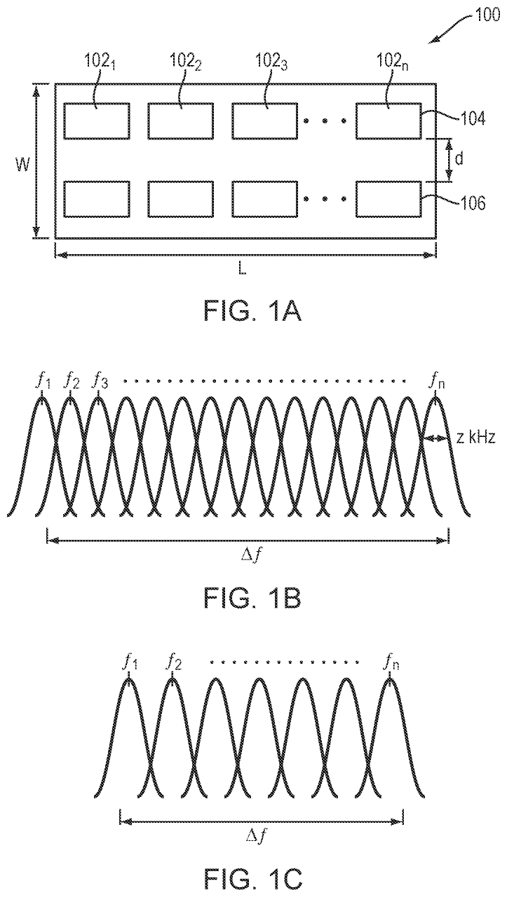

Refer first to FIG. 1A, which depicts an exemplary micro-antenna array 100 in accordance with various embodiments. The micro-antenna array 100 includes multiple micro-antenna elements 102 arranged in one or more series 104, 106 as further described below. In addition, the micro-antenna array 100 typically has dimensions comparable to a conventional chip (e.g., ranging from a few square millimeters (mm²) to approximately 600 mm²) such that the array 100 can be manufactured thereon. (As used herein, the term “comparable” means ±10%, and in some embodiments, ±5%.) For example, the length, L, of the array 100 may be approximately one inch, and the width, W, may be approximately ½ inch. In one embodiment, each micro-antenna element 102 is an acoustically actuated ultra-compact NEMS ME antenna having a suspended ferromagnetic/piezoelectric thin-film heterostructure. Due to the strong ME coupling between EM and bulk acoustic waves in the resonant ME heterostructures (ferromagnetic/piezoelectric), the micro-antenna element 102 may operate at a peak frequency between 30 Hz and 3 GHz while having 1-2 orders of magnitude miniaturization over conventional compact antennas. NEMS ME antennas are described in detail, for example, in Nan et al., “Acoustically Actuated Ultra-Compact NEMS magnetoelectric antennas,” Nature Communications 8:296 (August 2017), the entire contents of which are incorporated herein by reference.

To mitigate the high-Q problem that degrades performance of NEMS ME antennas, the material and/or configuration (e.g., size or shape) associated with each micro-antenna element 102 herein may be selected to limit its bandwidth to a relatively narrow range (e.g., 2 kHz). In addition, adjacent micro-antenna elements 102 may have a stepped-frequency difference (e.g., 100 kHz) between the peak operating frequencies associated therewith, and the frequency bands (or frequency ranges) of the micro-antenna elements 102 in the micro-antenna array 100 may collectively span a wide spectral region (e.g., from 10 kHz to 10 GHz). For example, referring to FIGS. 1B and 1C, each micro-antenna element corresponds to a frequency-response curve 108 having a frequency range; in one embodiment, the frequency range is defined by a relatively narrow bandwidth and a peak operating frequency f. For example, the lower and upper bounds of the frequency range may be defined as f−½ bandwidth and f+½ bandwidth, respectively. As depicted, the peak operating frequencies, f₁, f₂, . . . , fₙ, may correspond to the micro-antenna element 102₁, 102₂, . . . , 102ₙ, respectively, in the micro-antenna array 100, and the frequency bands of the micro-antenna element 102₁, 102₂, . . . , 102ₙ collectively span a wide frequency range Δf. In addition, the frequency bands corresponding to the peak operating frequencies f₁, f₂, . . . , fₙ may overlap one another (FIG. 1B) or may abut one another (FIG. 1C). In some embodiments, all (or at least some) of the micro-antenna elements have the same operating frequency range (i.e., the same peak operating frequency and same bandwidth).

In some embodiments, each micro-antenna element 102 in the array 100 is independently controlled to transmit and/or receive signals in its associated frequency range. Alternatively, the micro-antenna elements 102 may be operated in a group manner such that the entire array 100 effectively acts as a single broadband transmitter and/or receiver. In one embodiment, the micro-antenna elements 102 in the array 100 are grouped into multiple series 104, 106; each series is independently controlled to transmit and/or receive signals within a collective frequency range associated with the micro-antenna elements 102 in the series. The frequency range Δf of different series may be substantially the same or different. In one embodiment, each series is a linear array and the spacing, d, between two series is approximately (or less than) one-tenth of the average wavelength associated with the elements 102 in air or on a substrate made of, for example, a dielectric material, a magnetic material, or an absorptive material so as to improve the lateral and/or longitudinal resolution.

In addition, the spacing between the two series 104, 106 of the micro-antenna elements 102 (or two micro-antenna elements 102) may be configured based on a target location resolution and the locations of the two series of micro-antenna elements (or two micro-antenna elements 102) in the micro-antenna array 100. In some embodiments, the series 104, 106 of micro-antenna elements 102 form a phased array and may receive multiple input signals and generate multiple output signals. Regardless of whether the micro-antenna elements 102 in the micro-antenna array 100 are operated in a grouped or individual manner, the signals transmitted and/or received by the micro-antenna elements 102 may be computationally combined to effectively cover the broadband spectral frequency range, Δf.

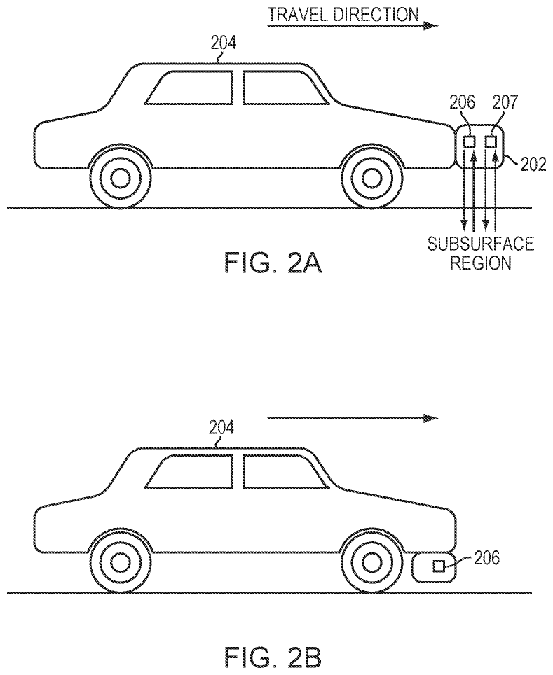

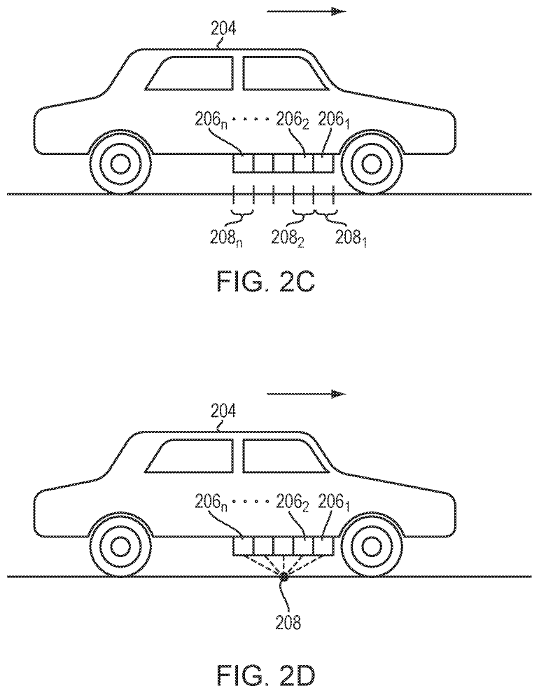

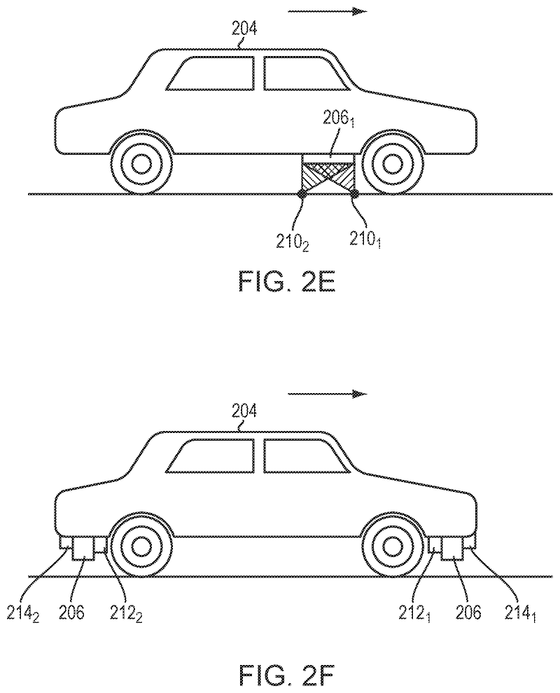

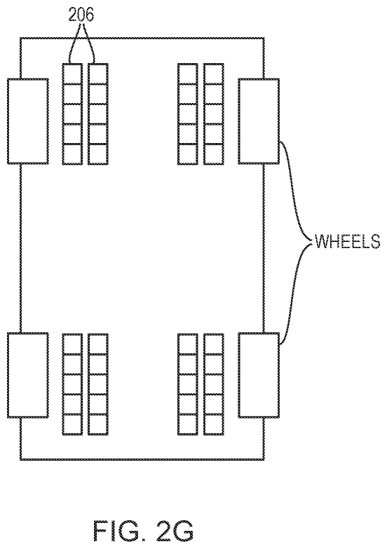

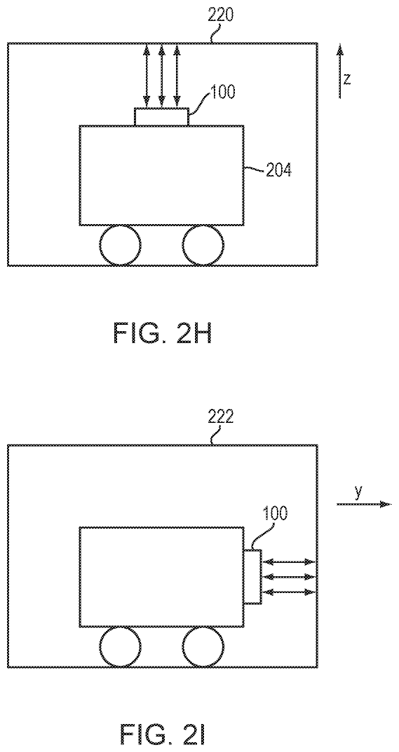

Referring to FIG. 2A, in various embodiments, the micro-antenna array 100 is implemented in an SPR system 202 affixed to a vehicle 204 and serves as an SPR antenna array 206 for acquiring road surface and/or subsurface information of the terrain conditions and/or locational information of the vehicle. In addition, the vehicle 204 may be equipped with a single antenna element 207 configured to operate at a frequency range different from any of the frequency range(s) associated the micro-antenna array(s); the single antenna element 207 and the micro-antenna arrays may substantially simultaneously acquire the real-time SPR information associated with the vehicle. The SPR antenna array 206 can be fixed underneath and/or to the front (or any suitable portion) of the vehicle 202. In addition, the SPR antenna array 206 is generally oriented parallel to the ground surface and may extend perpendicular to the direction of travel. In an alternative configuration, the SPR antenna array 206 is closer to or in contact with the surface of the road (FIG. 2B). In one embodiment, the SPR antenna array 206 transmits SPR signals to the road; the SPR signals propagate through the road surface into the subsurface region and are reflected in an upward direction. The reflected SPR signals can be detected by the receiving micro-antenna elements in the SPR antenna array 206. In various embodiments, the detected SPR signals are then processed and analyzed to generate one or more SPR images of the subsurface region along the track of the vehicle 204. In one embodiment, the SPR images are processed to extract features used to map and localize the vehicle 204. If the SPR antenna array 206 is not in contact with the surface, the strongest return signal received may be the reflection caused by the road surface. Thus, the SPR images may include (or may be dominated by) surface data, i.e., data for the interface of the subsurface region with air or the local environment.

In some embodiments, the SPR images are compared to SPR reference images that were previously acquired and stored for subsurface regions that at least partially overlap the subsurface regions for the defined route. The image comparison may be a registration process based on, for example, correlation; see, e.g., U.S. Pat. No. 8,786,485 and U.S. Patent Publication No. 2013/0050008, the entire disclosures of which are incorporated by reference herein. The route and/or location of the vehicle 204 and/or the terrain conditions of the route can be determined based on the comparison. In one embodiment, the route data is used to create a real-time map including the SPR information for navigating the vehicle 204. For example, based on the real-time SPR map information, the velocity, acceleration, orientation, angular velocity and/or angular acceleration of the vehicle 204 may be continuously controlled via a controller (further described below) so as to maintain travel of the vehicle 204 along a predefined route.

In some embodiments, the detected SPR signals are combined with other real-time information, such as the weather conditions, electro-optical (EO) imagery, vehicle health monitoring using one or more sensors employed in the vehicle 204, and any other suitable inputs, to estimate the terrain conditions of the route. The estimated terrain conditions may advantageously provide real-world terrain modeling as well as reduced computational expenses and/or complexity for modeling the terrain/vehicle interaction in real-time.

Referring to FIG. 2C, in various embodiments, the SPR system 202 includes multiple micro-antenna arrays 206₁₋ₙ; each array 206 corresponds to a different ground region 2081-n. Because different ground regions may include different terrain features, which in turn result in different SPR signals (e.g., having different amplitudes) received by the micro-antenna arrays 206₁₋ₙ, implementation of the multiple micro-antenna arrays 206₁₋ₙ may ensure that at least one of the micro-antenna arrays 206₁₋ₙ can receive strong SPR signals for accurately identifying the terrain conditions and/or the location of the vehicle. Referring to FIG. 2D, in some embodiments, each of the micro-antenna arrays 206₁₋ₙ is directed to the same ground region 208 but at a different angle. As a result, the micro-antenna elements in each array 206 may receive signals along a different angle off the same ground region 208. By combining and/or comparing the signals received by different arrays, the features associated with the underlying terrain of the region 208 and/or the location of the vehicle may be more accurately detected.

Additionally or alternatively, the phases of the micro-antenna elements in one or more of the micro-antenna arrays 206₁₋ₙ may be dynamically varied so as to focus in different directions/locations. For example, referring to FIG. 2E, by varying the relative phases of the micro-antenna elements in array 206₁, a steering beam can be created to focus at a region between regions 2101 and 2102. And again, by comparing the SPR signals from the different directions/locations steered by the steering beam, features associated with the underlying terrain in the steered directions/locations and/or the location of the vehicle can be detected. In one embodiment, each micro-antenna element is employed as a transceiver capable of generating the steering beam and receiving signals from the steered region/direction.

Additionally or alternatively, separate sets of micro-antenna arrays 206 may be distributed around the vehicle on which the SPR system 202 is implemented. For example, referring to FIGS. 2F (side view) and 2G (bottom view), one or more micro-antenna arrays 206 may be affixed to the front side/bottom of the vehicle 204, and another micro-antenna array(s) 206 may be affixed to the rear side/bottom of vehicle 204. As described above, the SPR signals obtained by the front and/or rear arrays may be converted to one or more images (or scans) including information of the surface and/or subsurface of the terrain around the vehicle 204. In addition, based on the obtained SPR signals, a real-time map including the SPR information may be created. Approaches for creating the real-time map using the SPR signals are provided, for example, in U.S. patent application Ser. No. 16/929,437 (filed on Jul. 15, 2020), the entire contents of which are incorporated herein by reference.

In one embodiment, the real-time SPR map information is transmitted from a controller 212₁ associated with the front array 206₁ to a controller 212₂ associated with the rear array 206₂ via communication modules 214₁, 214₂. The controllers 210₁, 210₂ may be implemented in hardware, software, or a combination of both, and may be different (e.g., identical) devices or integrated as a single device. Based on the received SPR map information, the rear controller 212₂ may record and register the SPR signals obtained by the rear array 206₂ to the signals received by the front array 206₁ during transmission of the SPR map information. In one embodiment, the controller 212₂ is configured to compare the data derived from signals obtained by the front array 206₁ and rear array 206₂ to determine state information, such as steering, orientation, velocity (speed and bearing), pose, acceleration and/or deceleration, during transmission of the SPR map information. Based thereon, a vehicle control module (further described below) may determine whether an action (e.g., a change of speed or bearing) is needed. That is, the front controller 212₁ periodically transmits state information to the rear controller 212₂, which then assesses the current state against previous states to make an independent control decision. Further details about registering the rear-array data to the front-array data are provided, for example, in U.S. patent application Ser. No. 16/933,395 (filed on Jul. 20, 2020), the entire contents of which are incorporated herein by reference.

Various embodiments described above relate to monitoring terrain conditions of the road in an outdoor surface environment. Alternatively, a vehicle may be controlled in an indoor environment, such as inside a building or within a complex of buildings. The vehicle can navigate hallways, warehouses, manufacturing areas and the like. In some embodiments, a vehicle may be controlled inside structures in regions that may be hazardous to humans, such as in a nuclear power facility, a hospital or a research facility where hazards may be present. Alternatively, the vehicle may be a mobile robot or other autonomous or controlled machinery capable of movement through a facility such as a factory or warehouse.

If the vehicle travels indoors, the SPR system 202 may be employed to obtain SPR images that include subsurface regions in and/or behind floors, ceilings or walls by attaching the SPR system 202 to, for example, the side or the top of the vehicle and orienting the SPR system in a preferred direction (which may be variable depending on the application, the vehicle's location, etc.). For example, FIG. 2H depicts a vehicle 204 traveling in the direction into or out of the page. The vehicle 204 is equipped with one or more micro-antenna arrays 100 configured to transmit and receive signals in a vertical direction, z, such that the subsurface region for the SPR images includes the region in and behind a ceiling 220 of the building. Similarly, FIG. 2I depicts a vehicle 204 traveling in the direction into or out of the page and having one or more micro-antenna arrays 100 implemented to transmit and receive signals in a horizontal direction, y, such that the subsurface region for the SPR images includes the region in and behind a vertical wall 222.

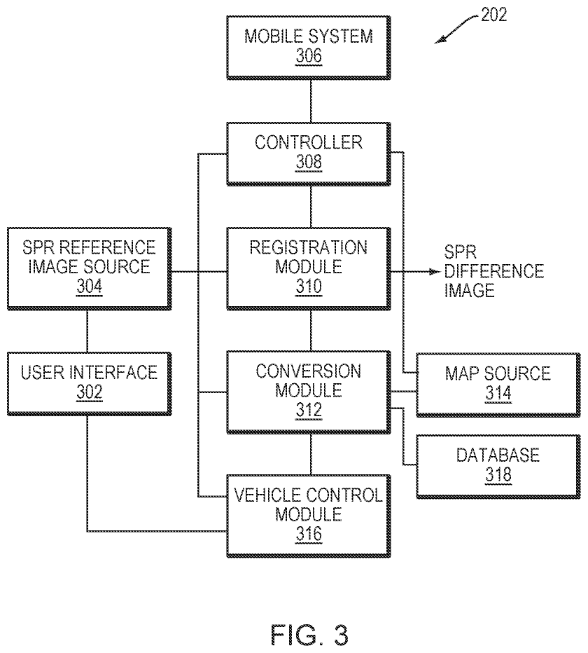

FIG. 3 depicts an exemplary terrain-monitoring system (e.g., the SPR system 202) having one or more micro-antenna arrays 100 implemented in a vehicle 204 in accordance herewith. The SPR system 202 may include a user interface 302 through which a user can enter data to define a route or select a predefined route. SPR images are retrieved from an SPR reference image source 304 according to the route. For example, the SPR reference image source 304 may be a local mass-storage device such as a Flash drive or hard disk; alternatively or in addition, the SPR reference image source 304 may be cloud-based (i.e., supported and maintained on a web server) and accessed remotely based on a current location determined by GPS. For example, a local data store may contain SPR reference images corresponding to the vicinity of the vehicle's current location, with periodic updates being retrieved to refresh the data as the vehicle travels.

The SPR system 202 also includes a mobile SPR system (“Mobile System”) 306 having one or more SPR antenna arrays (e.g., micro-antenna arrays 100) as described above. The transmitting operation of the mobile SPR system 306 is controlled by one or more controllers (e.g., processors) 308 that also receive the return SPR signals detected by the SPR antenna arrays. The controller(s) 308 may generate SPR images of the subsurface region below the road surface and/or the road surface underneath the SPR antenna arrays.

The SPR image includes features representative of structure and objects within the subsurface region and/or on the road surface, such as rocks, roots, boulders, pipes, voids and soil layering, and other features indicative of variations in the soil or material properties in the subsurface/surface region. In various embodiments, a registration module 310 compares the SPR images provided by the controller(s) 308 to the SPR images retrieved from the SPR reference image source 304 to determine the terrain conditions of the road and/or locate the vehicle 204 (e.g., by determining the offset of the vehicle with respect to the closest point on the route). In addition, the registration module 310 may compare the SPR images acquired by different SPR antenna arrays affixed to the vehicle 204 to identify anomalies in the underlying terrain and/or the pose, velocity, and/or change in acceleration of the vehicle 204. In various embodiments, the locational information (e.g., offset data or positional error data) determined in the registration process is provided to a conversion module 312 that creates a navigation map for navigating the vehicle 204. For example, the conversion module 312 may generate GPS data corrected for the vehicle positional deviation from the route.

Alternatively, the conversion module 312 may retrieve an existing map from a map source 314 (e.g., other navigation systems, such as GPS, or a mapping service), and then localize the obtained locational information to the existing map. In one embodiment, the location map of the predefined route is stored in a database 216 in system memory and/or a storage device accessible to the controller 208. Additionally or alternatively, the location data for the vehicle 104 may be used in combination with the data provided by an existing map (e.g., a map provided by GOOGLE MAPS) and/or one or more other sensors or navigation systems, such as an inertial navigation system (INS), a GPS system, a sound navigation and ranging (SONAR) system, a LIDAR system, a camera, an inertial measurement unit (IMU) and an auxiliary radar system, one or more vehicular dead-reckoning sensors (based on, e.g., steering angle and wheel odometry), and/or suspension sensors to guide the vehicle 204. For example, the controller 308 may localize the obtained SPR information to an existing map generated using GPS. Approaches for utilizing the SPR system for vehicle navigation and localization are described in, for example, U.S. Pat. No. 8,949,024, the entire disclosure of which is hereby incorporated by reference.

In some embodiments, the SPR reference images also include terrain conditions associated therewith. Thus, by comparing the obtained SPR images to the SPR reference images, the terrain conditions associated with the SPR reference images acquired from the route may be determined. Again, the determined terrain conditions may then be provided to the conversion module 312 for creating a terrain map. The terrain map, in turn, may be combined with the navigation map described above. The terrain/navigation map may then be provided to a vehicle control module 316 coupled to the controller(s) 308 for autonomously operating the vehicle based thereon. For example, the vehicle control module 316 may include or cooperate with electrical, mechanical and pneumatic devices in the vehicle to control steering, orientation, velocity, pose and acceleration/deceleration of the vehicle. In some embodiments, the SPR system 202 includes an input database 318 that continuously feeds other real-time information (other than the SPR signals/SPR images), detected by other systems, to the conversion module 312 for updating and/or refining the terrain/navigation map.

It should be noted that the terrain condition and/or locational information associated with the vehicle described above are exemplary information that can be obtained from the SPR signals. One of ordinary skill in the art will understand that based on the acquired SPR signals and approaches described above, other information such as the terrain feature(s), locational information with the feature(s), state of the feature(s), material characteristics or properties associated with the feature(s), changes in feature(s) in the subsurface or on the surface, and/or the velocity, pose, orientation, acceleration and/or state of the vehicle, etc. can also be obtained and is thus within the scope of the present invention.

The controller(s) 212, 308 implemented in the vehicle may include one or more modules implemented in hardware, software, or a combination of both. For embodiments in which the functions are provided as one or more software programs, the programs may be written in any of a number of high level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80x86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

In addition, the communication modules 214₁, 214₂ may include a conventional component (e.g., a network interface or transceiver) designed to provide wired and/or wireless communications therebetween. In one embodiment, the communication modules 214₁, 214₂ directly communicate with each other. Additionally or alternatively, the communication modules 214₁, 214₂ may indirectly communicate with each other via infrastructure, such as the public telecommunications infrastructure, a roadside unit, a remote platooning coordination system, a mobile communication server, etc. The wireless communication may be performed by means of a wireless communication system with WiFi, Bluetooth, infrared (IR) communication, a phone network, such as general packet radio service (GPRS), 3G, 4G, 5G, Enhanced Data GSM Environment (EDGE), or other non-RF communication systems such as an optical system, etc. In addition, the wireless communication may be performed using any suitable modulation schemes, such as AM, FM, FSK, PSK, ASK, QAM, etc.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A system for navigating a vehicle on a terrain comprising:
a surface-penetrating radar (SPR) system comprising at least one micro-antenna array for acquiring real-time SPR information associated with the vehicle, the micro-antenna array comprising a plurality of micro-antenna elements each being configured to operate at a frequency range, the frequency ranges of the micro-antenna elements collectively spanning a full frequency range greater than the frequency range of an individual one of the micro-antenna elements; and
at least one controller configured to, based at least in part on the acquired real-time SPR information, determine information associated with at least one of the terrain or the vehicle.

2. The system of claim 1, wherein each of the micro-antenna elements comprises an acoustically actuated ultra-compact nanoelectromechanical system (NEMS) ME antenna and has a suspended ferromagnetic/piezoelectric thin-film heterostructure.

3. The system of claim 1, wherein each of the micro-antenna elements has dimensions comparable to those of a conventional microchip.

4. The system of claim 1, wherein the full frequency range corresponds to frequencies between 10 kHz and 10 GHz.

5. The system of claim 1, wherein each micro-antenna element has a peak operating frequency, the peak operating frequencies associated with adjacent micro-antenna elements having a stepped-frequency difference.

6. The system of claim 1, wherein the frequency ranges of adjacent micro-antenna elements overlap each other.

7. The system of claim 1, wherein the frequency ranges of adjacent micro-antenna elements abut each other.

8. The system of claim 1, wherein the micro-antenna elements are operable over approximately 2 kHz.

9. The system of claim 1, wherein the SPR system comprises a plurality of micro-antenna arrays, each configured to focus at a different region, the controller being further configured to:
compare the SPR information received by the micro-antenna arrays; and
determine anomalies in the terrain condition associated with at least one of the regions.

10. The system of claim 1, wherein the controller is further configured to:
cause the micro-antenna array to generate a steering beam focusing at a plurality of regions;
compare the SPR information received by the micro-antenna array from the plurality of regions; and
determine anomalies in the terrain condition associated with at least one of the regions.

11. The system of claim 1, wherein the SPR system comprises a plurality of micro-antenna arrays, each configured to focus at a different region, the controller being further configured to: based on the SPR information acquired by a first one of the micro-antenna arrays, map the terrain condition;
based on the map, record and register the SPR information acquired by a second one of the micro-antenna arrays to the SPR information acquired by the first one of the micro-antenna arrays; and
determine state information associated with the vehicle.

12. The system of claim 11, wherein the state information comprises at least one of a steering direction, an orientation, a velocity, a pose, an acceleration or a deceleration.

13. The system of claim 1, wherein the micro-antenna array is configured to receive a plurality of input signals or generate a plurality of output signals at one time so as to shape a beam generated therefrom or improve quality of the acquired real-time SPR information.

14. The system of claim 1, wherein the micro-antenna array is configured in two-dimensional or three-dimensional.

15. The system of claim 1, wherein the controller is further configured to combine or compare the acquired real-time SPR information over a time period so as to improve accuracy of the determined terrain condition and/or locational information associated with the vehicle.

16. The system of claim 1, wherein the micro-antenna elements are spaced apart from one another with a distance less than one-tenth of an average operating wavelength of the micro-antenna elements in air or on a substrate so as to improve a lateral and/or longitudinal resolution.

17. The system of claim 1, wherein a space between at least two of the micro-antenna elements is determined based at least in part on a target location resolution and locations of the at least two micro-antenna elements in the micro-antenna array.

18. The system of claim 1, wherein the micro-antenna elements have the same frequency range.

19. The system of claim 1, wherein at least some the micro-antenna elements have different frequency ranges.

20. The system of claim 1, further comprising a single antenna element for acquiring real-time SPR information associated with the vehicle at a frequency range different from the frequency ranges of the micro-antenna elements.

21. A method of navigating a vehicle on a terrain comprising:
providing a surface-penetrating radar (SPR) system comprising at least one micro-antenna array, the micro-antenna array comprising a plurality of micro-antenna elements, each being configured to operate at a frequency range, the frequency ranges of the micro-antenna elements collectively spanning a full frequency range;
activating the SPR system to acquire real-time SPR information associated with the vehicle; and
based at least in part on the acquired real-time SPR information, determining information associated with at least one of the terrain or the vehicle.

22. The method of claim 21, wherein the wide frequency range corresponds to frequencies between 10 kHz and 10 GHz.

23. The method of claim 21, wherein each micro-antenna element has a peak operating frequency, the peak operating frequencies associated with adjacent micro-antenna elements having a stepped-frequency difference.
